(19) United States
(12) Patent Application Publication
(10) Pub. No.: US 2008/0163892 A1
(43) Pub. Date: Jul. 10, 2008

(54) CLEANING WAFER INCLUDING DETERGENT LAYER FOR EXPOSURE APPARATUS OF IMMERSION LITHOGRAPHY SYSTEM, COMPOSITION OF DETERGENT LAYER, METHOD OF USING CLEANING WAFER AND APPLICATION SYSTEM

(75) Inventors: I-Hsiung Huang, Hsinchu County (TW); Ling-Chieh Lin, Taichung County (TW)

Correspondence Address: J C PATENTS, INC., 4 VENTURE, SUITE 250, IRVINE, CA, 92618, US

(73) Assignee: UNITED MICROELECTRONICS CORP., HSINCHU (TW)

(21) Appl. No.: 11/621,002

(22) Filed: Jan. 8, 2007

(51) Int. Cl. B08B 3/08; C11D 7/00; B08B 7/00

(52) U.S. Cl. 134/2; 510/175; 134/93

(57) ABSTRACT

A method of an in situ cleaning of an objective lens of a semiconductor apparatus includes placing a cleaning wafer having a detergent layer on a scanning stage of the semiconductor apparatus. A cleaning composition in the detergent layer is dissolved by using an immersion liquid (water), so that the cleaning composition reacts with the contaminants on the objective lens. Thereafter, the objective lens is rinsed with another solvent.

### BACKGROUND OF THE INVENTION

1. Field of Invention

The present invention relates to a method and an apparatus for cleaning a semiconductor system. More particularly, the present invention is related to a cleaning wafer applicable to an exposure apparatus of an immersion lithography system and an objective lens of the exposure apparatus, an in situ cleaning method using the cleaning wafer, and a composition of a coating layer of the cleaning wafer.

2. Description of Related Art

In the semiconductor industry, methods used in scaling down the linewidth typically include reducing the wavelength of an exposure light to enhance resolution. However, the new-generation 157 nm lithograph process confronts with numerous problems, such as the application of brand new laser source, photomask, objective lenses that can reduce the image and exposure light positions, and photoresist reagent, etc. Below 157 nm, it is difficult to fabricate lenses of calcium fluoride for the lenses either have too many defects or significant aberrations are resulted. Ultimately, it is unable to project a clear image onto the wafer. The development of the immersion lithograph technique in 2002 allows the enhancement of resolution based on the current 193 nm lithograph and the pursuance of the 157 nm technique is no longer imminent. The immersion lithograph is a technique that interposes a liquid medium between the optical source and the wafer surface in a 193 nm exposure system to reduce the wavelength to 132 nm, so that the 65 nm, the 45 nm and even the 32 nm processes that are beyond the capability of current dry lithography systems can be supported.

During the application of an immersion exposure apparatus in a lithograph process, the liquid medium between the objective lens and the wafer may penetrate into the photoresist layer on the wafer. A portion of the photoresist layer may decompose and residues may remain on the objective lens. Further, during the exposure process, the dissolved substance in the photoresist is evaporated and outgassing is resulted, which ultimately may deposit on and contaminate the objective lens.

Currently, the cleaning of the objective lens of an exposure apparatus is directly provided by the vendor. Not only the cleaning of the objective lens is time consuming and costly, the objective lens is often not completely cleaned, which then requires a re-cleaning of the objective lens.

### SUMMARY OF THE INVENTION

The present invention is to provide an apparatus and a method for effectively cleaning the objective lens of a semiconductor apparatus without the assistance of the vendor, wherein not only the cost is low and time is preserved, the apparatus is easy to operate and does not occupy additional space.

The present invention is to provide an apparatus and a method for effectively cleaning an objective lens of an exposure device of an immersion lithograph system in situ without the assistance of the vendor, wherein not only the cost is low, time is preserved, the apparatus is easy to operate and does not occupy additional space.

The present invention is to provide a cleaning wafer, wherein the manufacturing of the cleaning wafer is simple. Further, the cleaning wafer may incorporate into a semiconductor process for cleaning an objective lens of a semiconductor apparatus.

The present invention is to provide a composition of a coating layer for cleaning, wherein the composition can be used to fabricate a cleaning wafer for cleaning am objective lens of a semiconductor apparatus.

The present invention is to provide an exposure apparatus of an immersion lithograph system, wherein the objective lens can be cleaned in-situ, and the manual cleaning of the lens provided by the vendor can be precluded.

The present invention is to provide a method for cleaning an objective lens of a semiconductor apparatus. The method includes providing a cleaning wafer, wherein the cleaning wafer includes a wafer and a detergent layer, and the detergent layer contains a cleaning component. Thereafter, a first solvent is provided to dissolve a portion of the cleaning component, allowing the cleaning component to react with the contaminants on the objective lens. Subsequently, a second solvent is used to rinse the objective lens.

According to an embodiment of the present invention, the above method for cleaning an objective lens of a semiconductor apparatus also includes moving the objective lens and the cleaning wafer relatively, and using again the first solvent to dissolve another portion of the cleaning component, allowing the cleaning component to react with the contaminants on the objective lens. The above process steps may further be repeated until the objective lens is completely cleaned.

According to an embodiment of the present invention, the cleaning wafer is formed according to the fabrication method of a photoresist layer.

According to an embodiment of the present invention, the above-mentioned fabrication method of a photoresist layer includes providing a composition containing a cleaning component. The composition is then coated on the wafer to form a coating layer. The coating layer is further baked to form a detergent layer.

In accordance to an embodiment of the present invention, the above composition includes 5 to 20 wt % of at least one surfactant as the cleaning component, 10 to 50 wt % of at least a solvent, 5-25 wt % of at least a film-forming polymer, and optionally 1 to 5% of an additive. The surfactant includes an amphoteric surfactant, for example. The solvent is selected from isopropyl alcohol, propylene glycol monomethylethyl acetate (PGMEA) and a combination thereof, for example. The additive includes but not limited to an algicide or a microbial inhibitor. The film-forming polymer is selected from novolac resin, polyhydroxy styrene resin, acrylate, methacrylate, cyclic olefin, alternating copolymer, hybrid polymer, cyclo polymer and any combination thereof, for example. The first solvent and the second solvent include but not limited to water or water after being subjected to an ultrasonic vibration.

The present invention is to provide an in-situ cleaning method for an objective lens of an exposure apparatus of an immersion lithograph system. The method includes providing a cleaning wafer on a wafer-scanning stage of the exposure apparatus. The cleaning wafer includes a wafer and a detergent layer. The detergent layer contains a cleaning component. Thereafter, a first solvent is continuously supplied to an immersion chamber above the wafer-scanning stage of the exposure apparatus to dissolve a portion of the cleaning component in the detergent layer in order for the cleaning component to react with the contaminants on the objective lens. Thereafter, a second solvent is supplied to the immersion chamber to rinse the objective lens.

According the an embodiment of the invention, the above-mentioned in situ cleaning method for an objective lens of an exposure apparatus of an immersion lithograph system further includes moving relatively the exposure apparatus and the cleaning wafer. Then, the first solvent is supplied to the immersion chamber of the exposure apparatus to dissolve another portion of the cleaning component of the detergent layer for the cleaning component to react with the contaminants on the objective lens. Thereafter, the second solvent is supplied again to rinse the objective lens. The above process steps may be repeated until the objective lens is completely cleaned.

According to an embodiment of the invention, the above-mentioned cleaning wafer is fabricated according the method of forming a photoresist layer.

According to an embodiment of the invention, the above-mentioned fabrication method of the cleaning wafer includes providing a composition containing a cleaning component. Thereafter, the composition is coated on a wafer to form a coating layer. The coating layer is further subjected to a baking process to form a detergent layer.

According to an embodiment of the invention, the composition includes, for example, 5 to 20 wt % of at least one surfactant as the cleaning component, 10 to 50 wt % of at least a solvent, 5-25 wt % of at least a film-forming polymer, and optionally 1 to 5% of an additive. The surfactant includes an amphoteric surfactant, for example. The solvent is selected from isopropyl alcohol and propylene glycol monomethylethyl acetate (PGMEA) and a combination thereof, for example. The additive includes but not limited to an algicide or a microbial inhibitor. The film-forming polymer is selected from novolac resin, polyhydroxy styrene resin, acrylate, methacrylate, cyclic olefin, alternating copolymer, hybrid polymer, cyclo polymer and any combination thereof, for example. The first solvent and the second solvent include but not limited to water or water after being subjected to an ultrasonic vibration.

According to an embodiment of the invention, the appropriate timing for cleaning the objective lens includes when the exposure apparatus is under testing, idling, preventive maintenance and/or before and/or after the exposure system performs a patterning process on a semiconductor device.

The present invention is to provide a cleaning wafer, which includes a wafer and a detergent layer disposed on the wafer, wherein the detergent layer is formed by a coating layer. The coating layer contains a composition, wherein the composition includes 5-20 wt % of at least one surfactant, 10-50 wt % of at least one solvent, 5-25 wt % of at least one film-forming polymer and optionally 1-5 wt % of an additive.

According to an embodiment of the present invention, the above surfactant includes an amphoteric surfactant. The solvent is selected from isopropyl alcohol and propylene glycol monomethylethyl acetate (PEMEA) and a combination thereof. The additive includes an algicid or a microbial inhibitor. The film-forming polymer is selected from novolac resin, polyhydroxy styrene resin, acrylate, metacrylate, cyclic olefin, alternating copolymer, hybrid polymer, cyclo polymer and a combination thereof.

The present invention also provides an exposure apparatus, applicable in an immersion lithograph system, wherein the objective lens of the exposure apparatus can be cleaned in-situ. The exposure apparatus includes an optical casing, an exposure light source, an objective lens, a wafer-scanning stage, an immersion chamber, a fluid supply/discharge system and a cleaning wafer. The exposure light source is disposed in the optical casing. The objective lens is disposed on the optical casing. The wafer-scanning stage is disposed under the objective lens for supporting the wafer. The immersion chamber, disposed under the objective lens and above the scanning stage for accommodating a fluid. The fluid supply/discharge system is used for supplying to and discharging fluid from the immersion chamber. The cleaning wafer is disposed on the wafer-scanning stage, for example to provide a cleaning component to the objective lens.

According to the embodiment of the present invention, the above exposure apparatus in which the objective lens can be cleaned in situ, further includes an ultrasonic vibrator, configured near the immersion chamber for example, to provide vibration to the fluid in the immersion chamber. Alternatively, the ultrasonic vibrator may configure near the fluid supply/discharge system, to provide an ultrasonic vibrated fluid to the immersion chamber.

The present invention provides an apparatus and a method for an effective cleaning of an objective lens, wherein the cost is low, time is preserved. Moreover, the apparatus is easy to operate and does not occupy additional space.

It is to be understood that both the foregoing general description and the following detailed description are exemplary, and are intended to provide further explanation of the invention as claimed.

### BRIEF DESCRIPTION OF THE DRAWINGS

FIG. 1 is a schematic cross-sectional view of a cleaning wafer according to an embodiment of the invention.

FIGS. 2A to 2B are schematic, cross-section views of two types of exposure apparatus of an immersion lithograph system.

FIG. 3 is a flow chart of steps in exemplary processes that may be used in an in situ cleaning of an exposure apparatus according to an embodiment of the invention.

FIG. 4 is a schematic diagram illustrating the relative positions of the objective lens and the cleaning wafer during a cleaning process.

### DESCRIPTION OF EMBODIMENTS

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

The present invention is to provide a cleaning wafer containing a detergent layer for cleaning a semiconductor apparatus in-situ, for example, an objective lens of an immersion exposure apparatus. During the cleaning process, the cleaning wafer is placed on a wafer-scanning stage, and a portion of the cleaning component in the cleaning wafer is dissolved by a solvent for the cleaning component to react with the contaminants on the objective lens. The objective lens is completely cleaned after being rinsed with another solvent.

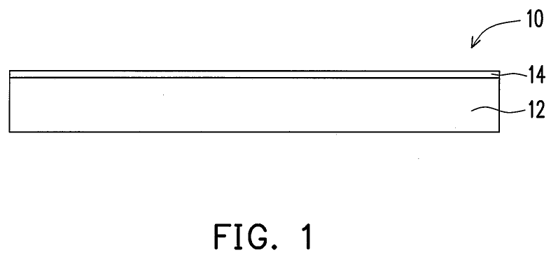

Referring to FIG. 1, a cleaning wafer 10 includes a wafer 12 and a detergent layer 14. The wafer 12 can be semiconductor wafer, such as a silicon wafer or a semiconductive compound wafer, such as a silicon-germanium wafer, or other substrate in which the detergent layer can be easily adhered to. The detergent layer 14, which is about 0.1 to 1.0 micron thick, is formed with a dried coating layer. The coating layer is formed by coating a composition containing a cleaning component, followed by a baking process, for example. The coating process is accomplished by methods include but not limited to spin coating. The baking temperature, for example, 90˜140° C., varies according to the components in the composition. The composition includes, for example, 5-20 wt % of at least a surfactant as the cleaning component, 10-50 wt % of at least a first solvent, 5-25 wt % of at least a film-forming polymer and optionally 1-5 wt % of an additive.

The surfactant serving as the cleaning component is, for example, an amphoteric surfactant, which includes, but not limited to, an imidazole compound having the following general formula:

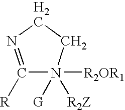

wherein R represents C₆ to C₂₄ hydrocarbon radial, such as a straight or branch, saturated or unsaturated, aliphatic hydrocarbon or an alkyl-aryl group in which the alkyl group contains at least six carbon atoms, and preferably a fatty acid radical; R₁ represents H, alkali metal, preferably Na, or CH₂COOM; the R₂ groups, which may be the same or different are C₁ to C₄ alkylene groups, such as —C, —CH₂—, —C₂H₄—, C₃H₆— or C₄H₈; Z represents —COOM or C(OH)HCH₂SO₃M, M is alkali metal, preferably Na, H or a nitrogen containing organic base radical; G represents OH, the salt of a C₆ to C₂₄ anionic surface active sulfate or sulfonate, such as a saturated or unsaturated aliphatic sulfate or sulfonate, or an alkyl-aryl sulfate or sulfonate in which the alkyl group contains at least 6 carbon atoms, or an acid salt.

The above-mentioned solvent is selected from isopropyl alcohol, propylene glycol monomethylethyl acetate (PGMEA) and a combination thereof. The film-forming polymer can be used to control the viscosity of the composition; thus, it is possible to form coating layers of different thicknesses when the composition is coated on a surface.

The film-forming polymer includes but not limited to novolac resin, such as I-line 365 type of novolac resin:

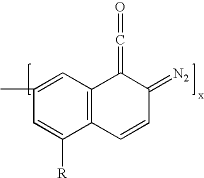

polyhydroxy styrene resin such as:

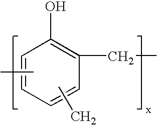

acrylate, methacrylate, such as

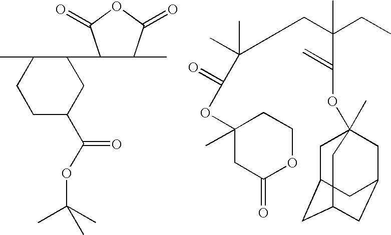

cyclic olefin, alternating copolymer, hybrid polymer and cyclo polymer or a combination thereof.

The additive includes but not limited to an algicide or a microbial inhibitor.

The cleaning component of the above composition can be dissolved in water. Accordingly, when the above cleaning wafer, formed with the above composition, is used to clean an apparatus, water can be used to dissolve the detergent layer of the cleaning wafer.

The cleaning wafer in the above embodiment is applicable to an immersion lithograph system. The objective lens of the exposure apparatus can be cleaned in-situ, and an example thereof is described hereinafter.

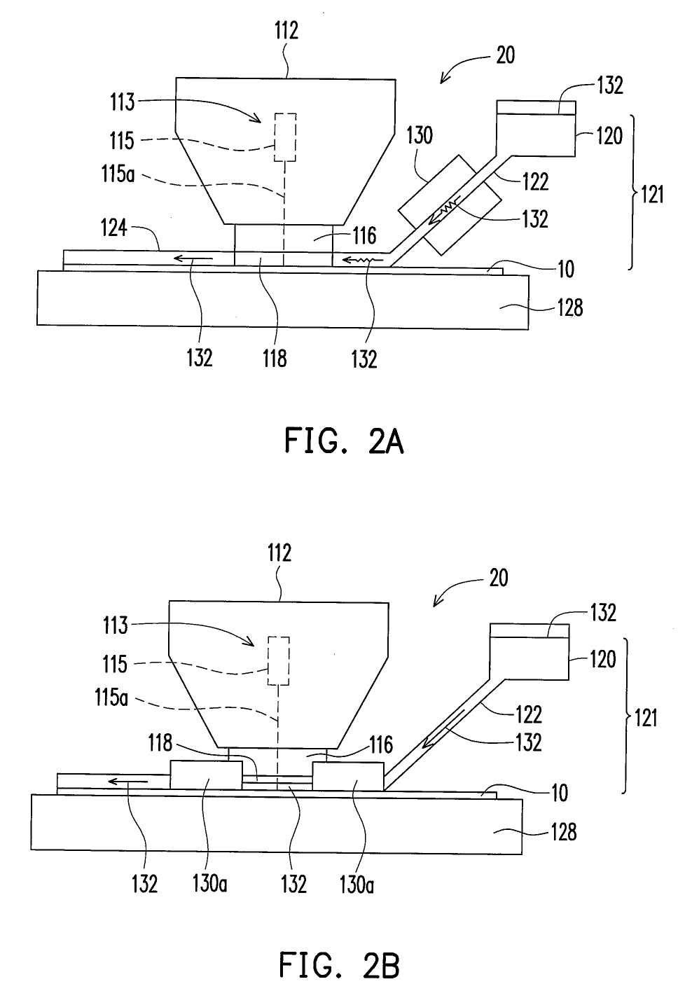

Referring to FIG. 2A, an exposure apparatus 20 of an immersion lithograph system includes a wafer-scanning stage 128, used to support a wafer formed with a photoresist layer thereon or a cleaning wafer 10 of the invention. The optical housing 112 includes an optical system 113 for accommodating a mask (not shown). The optical system 113 includes a light source 115, for example a laser, and an objective lens 116 configured correspondingly above the wafer-scanning stage 128. The immersion chamber 118, configured below the objective lens 116 and above the scanning stage 128, is used for accommodating a liquid 132, for example, an exposure medium, such as water or a solvent used in dissolving the detergent layer of the invention, for example, water.

The immersion chamber 118 can be an air-tight chamber, formed by supplying an inert gas through a gas inlet conduit (not shown). The liquid in the immersion chamber 118 is supplied by a liquid-supply/discharge system 121. The liquid supply/discharge system 121 includes a reservoir 120 and a supply conduit 122 and a discharge conduit 124. The liquid 132 stored in the reservoir 120 is delivered to the immersion chamber 118 through the supply conduit 122, while the liquid in the immersion chamber 118 is discharged via the discharge conduit 124.

The exposure apparatus 20 may further includes an ultrasonic vibrator 130 or 130a, as shown in FIGS. 2A and 2B. The ultrasonic vibrator 130 may configure near the supply conduit 122 to vibrate the solvent. Accordingly, the solvent delivered to the immersion chamber 118 has already been subjected to an ultrasonic vibration, as shown in FIG. 2A. Alternatively, the ultrasonic vibrator 130a is disposed near the immersion chamber 118 to vibrate the solvent in the immersion chamber 118.

During the lithograph process, a light beam 115a, for example, a laser light beam, is transmitted through the objective lens 116 and the medium in the immersion chamber 18 onto the photoresist, and the image in the mask is transferred to the photoresist on the wafer.

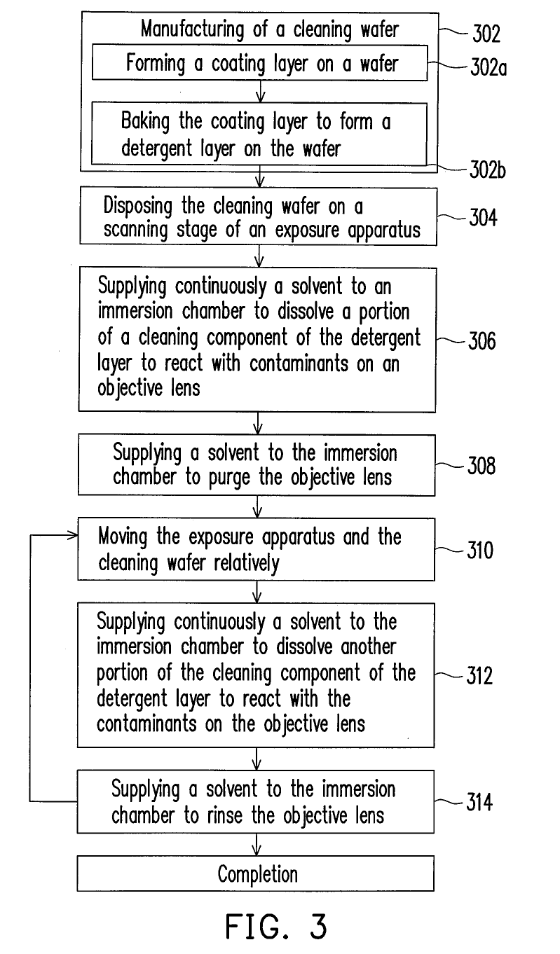

Subsequent to the patterning process of a semiconductor device, a cleaning process is performed to remove the contaminants on the objective lens 116 of the exposure apparatus. The flow of the cleaning process is summarized in FIG. 3.

Referring concurrently to FIGS. 2A and 3, the cleaning process is commenced by first fabricating the cleaning wafer 10 as in step 302. The fabrication method of the cleaning wafer is similar to the conventional method for fabricating a photoresist layer on a wafer. In essence, the above-mentioned composition for forming the detergent layer 14 is spin-coated on the wafer 12 to form a coating layer in step 302a, for example, using a typical spin-coater for spin-coating a photoresist layer. Thereafter, an oven for baking a photoresist layer is used to bake the coating layer to form the detergent layer 14 as in step 302b.

Thereafter, the cleaning wafer 10 is disposed on the wafer-scanning stage 128 of the exposure apparatus as in step 304. Continuing to step 306, a solvent is continuously supplied to the immersion chamber 118 through the supply conduit 122 of the liquid supply/discharge system 121. The solvent is used for dissolving a portion of the cleaning component of the detergent film 14 and to provide a driving force to discharge the solvent after reacting with the contaminants on the objective lens 116. The solvent supplied to the immersion chamber includes but not limited to water. The flow rate of the solvent in the immersion chamber is controlled to regulate the concentration of the cleaning component of the detergent layer 14 dissolved in the solvent. In one embodiment, the solvent supplied to the immersion chamber 118 is water, and the flow rate is about 50 to 800 milliliter/minute. Further, an ultrasonic vibrator 130 may be disposed at the supply conduit 122 to vibrate the solvent. Thus, the solvent that is being delivered to the immersion chamber 118 has already been vibrated. Alternatively, an ultrasonic vibrator 13 a may be disposed near the immersion chamber 118 to vibrate the solvent after the solvent is being supplied to the immersion chamber 118, as shown in FIG. 2A, to enhance the cleaning efficiency.

Thereafter, in step 308, a solvent is provided, via the supply conduit 122 of the liquid supply/discharge system 121, to rinse the objective lens. The solvent provided in step 308 is water, for example.

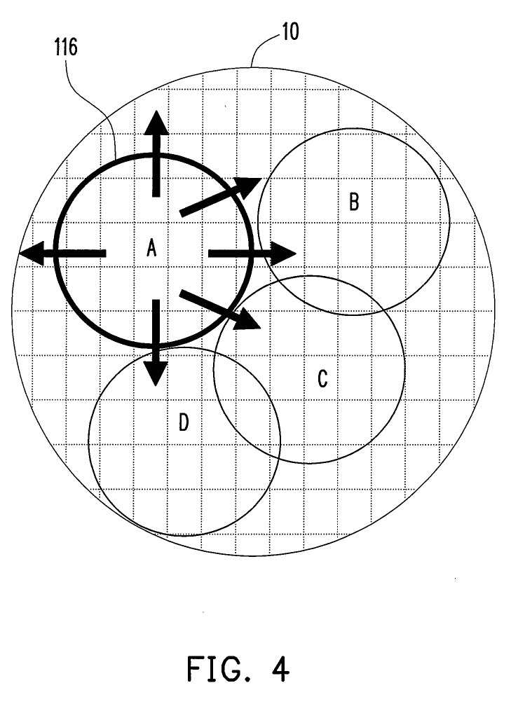

Continuing to step 310, the exposure apparatus 20 and the cleaning wafer 10 are moved relatively so that the objective lens 116 and the cleaning wafer 10 are configured relatively in different positions to perform a second cleaning process. There is no particular limitation on the moving directions of the exposure apparatus 20 and the cleaning wafer 10. For example, referring to FIG. 4, the position of the objective lens 116 relative to the cleaning wafer 116 includes moving from A to B, C, or D. The exposure apparatus 20 and the cleaning wafer 10 are moved relatively at a rate below 100 centimeter/second, for example.

In step 312, a solvent is again supplied to the immersion chamber 118 of the exposure apparatus 20 to dissolve another portion of the cleaning component of the detergent layer 14 for the cleaning component to react with the contaminants on the objective lens 116. Step 312 can be performed with a method similar to the one described in step 306.

In step 314, the objective lens is rinsed with a solvent. Step 314 can be performed with a method similar to the one described in step 308.

If the objective lens is not completely cleaned after performing step 314, steps 310 to 314 can be repeated until the lens is fully cleaned.

To ensure the lithographic quality, the above cleaning process may be conducted before the exposure apparatus is used for the patterning process of a semiconductor device. Alternatively, the cleaning process may be performed when the exposure apparatus is under testing, idling or preventive maintenance.

The cleaning method of the present invention can be incorporated into the existing immersion lithograph process. Further, service by the vendor or installation of additional equipments is precluded. Moreover, the cleaning of an immersion type of exposure apparatus can be conducted in-situ by internal staff and a shutdown can be obviated. Further, only a reasonable amount of cleaning solvent is consumed during the cleaning process. Accordingly, the present invention provides an apparatus and a method for an effective cleaning of an objective lens, in which the cost is low, time is preserved. Moreover, the apparatus is easy to operate and does not occupy additional space.

What is claimed is:

1. A method for cleaning an objective lens of a semiconductor apparatus, the method comprising:
providing a cleaning wafer, the cleaning wafer comprising a wafer and a detergent layer, wherein the detergent layer comprises a cleaning component;
providing a first solvent to dissolve a portion of the cleaning component of the detergent layer to react with contaminants on the objective lens; and
purging the objective lens with a second solvent.

2. The method of claim 1 further comprising:
a. moving relatively the objective lens and the cleaning wafer;
b. by using the first solvent, dissolving another portion of the cleaning component of the detergent layer to react with the contaminants on the objective lens;
c. purging the objective lens with the second solvent; and
d. repeating steps a to c until the objective lens is completely cleaned.

3. The method of claim 1, wherein the cleaning wafer is fabricated according to a fabrication method of a photoresist layer.

4. The method of claim 3, wherein the fabrication method of the photoresist layer comprises:
providing a composition comprising the cleaning component,
coating the composition on the wafer to form a coating layer; and
baking the coating layer to form the detergent layer.

5. The method of claim 3, wherein the composition comprises:
5-20 wt % of at least one surfactant as the cleaning component;
10-50 wt % of at least a third solvent;
5-25 wt % of at least one film-forming polymer; and
optionally 1-5 wt % of an additive.

6. The method of claim 5, wherein the surfactant includes an amphoteric surfactant.

7. The method of claim 5, wherein the third solvent is selected from the group consisting of isopropyl alcohol and propylene glycol monomethylethyl acetate (PGMEA) and a combination thereof.

8. The method of claim 5, wherein the additive comprises an algicide or a microbial inhibitor.

9. The method of claim 5, wherein the film-forming polymer is selected from the group consisting of novolac resin, polyhydroxy styrene resin, acrylate, methacrylate, cyclic olefin, alternating copolymer, hybrid polymer, cyclo polymer and a combination thereof.

10. The method of claim 1, wherein the first solvent and the second solvent include water or water after being subjected to an ultrasonic vibration.

11. An in-situ cleaning method for an objective lens of an exposure apparatus of an immersion lithograph system, the method comprising:
providing a cleaning wafer on a wafer-scanning stage of the exposure apparatus, the cleaning wafer comprising a wafer and a detergent layer, and the detergent layer comprising a cleaning component;
continuously supplying a first solvent to an immersion chamber above the wafer-scanning stage of the exposure apparatus, wherein the first solvent dissolves a portion of the cleaning component of the detergent layer to react with contaminants on the objective lens; and
supplying a second solvent to the immersion chamber to rinse the objective lens.

12. The in-situ cleaning method of claim 11 further comprising:
moving the exposure apparatus and the cleaning wafer relatively;
supplying again the first solvent to the immersion chamber of the exposure apparatus, wherein the first solvent dissolves another portion of the cleaning component to react with the contaminants on the objective lens; and
repeating the above steps until the objective lens is completely cleaned.

13. The in-situ cleaning method of claim 11, wherein the cleaning wafer is fabricated according to a fabrication process of a photoresist layer.

14. The in-situ cleaning method of claim 13, wherein the fabrication process of the cleaning wafer comprises:
providing a composition comprising the cleaning component,
coating the composition on the wafer to form a coating layer; and
baking the coating layer to form the detergent layer.

15. The in-situ cleaning method of claim 14, wherein the composition comprises:
5-20 wt % of at least one surfactant as the cleaning component;
10-50 wt % of at least a third solvent;
5-25 wt % of at least one: film-forming polymer; and
optionally 1-5 wt % of an additive.

16. The in-situ cleaning method of claim 15, wherein the surfactant includes an amphoteric surfactant.

17. The in-situ cleaning method of claim 15, wherein the third solvent is selected from the group consisting of isopropyl alcohol and propylene glycol monomethylethyl acetate (PGMEA) and a combination thereof.

18. The in-situ cleaning method of claim 15, wherein the additive comprises an algicide or a microbial inhibitor.

19. The in-situ cleaning method of claim 15, wherein the film-forming polymer is selected from the group consisting of novolac resin, polyhydroxy styrene resin, acrylate, methacrylate, cyclic olefin, alternating copolymer, hybrid polymer, cyclo polymer, and a combination thereof.

20. The in-situ cleaning method of claim 15, wherein the first solvent and the second solvent include water or water after being subjected to an ultrasonic vibration.

21. The in-situ cleaning method of claim 11, wherein the cleaning method is performed when the exposure apparatus is under testing, idling, or preventive maintenance.

22. A cleaning wafer comprising:
a wafer; and
a detergent layer, disposed on the wafer, wherein the detergent layer includes a dried coating layer and the coating layer comprises a composition, the composition comprises:
5-20 wt % of at least a surfactant as the cleaning component;
10-50 wt % of at least a third solvent;
5-25 wt % of at least a film-forming polymer; and
optionally 1-5 wt % of an additive.

23. The cleaning wafer of claim 22, wherein the surfactant comprises an amphoteric surfactant.

24. The cleaning wafer of claim 22, wherein the solvent is selected from the group consisting of isopropyl alcohol and propylene glycol monomethylethyl acetate (PGMEA) and a combination thereof.

25. The cleaning wafer of claim 22, wherein the additive comprises an algicide or a microbial inhibitor.

26. The cleaning wafer of claim 22, wherein the film-forming polymer is selected from the group consisting of novolac resin, polyhydroxy styrene resin, acrylate, methacrylate, cyclic olefin, alternating copolymer, hybrid polymer, cyclo polymer, and a combination thereof.

27. A composition of a detergent layer of a cleaning wafer, the composition comprising:
5-20 wt % of at least a surfactant;
10-50 wt % of at least a solvent;
5-25 wt % of a film-forming polymer; and
optionally 1-5 wt % of an additive.

28. The composition of claim 27, wherein the surfactant comprises an amphoteric surfactant.

29. The composition of claim 27, wherein the solvent is selected from the group consisting of isopropyl alcohol and propylene glycol monomethylethyl acetate (PGMEA) and a combination thereof.

30. The composition of claim 27, wherein the additive comprises an algicide or a microbial inhibitor.

31. The cleaning wafer of claim 27, wherein the film-forming polymer is selected from the group consisting of novolac resin, polyhydroxy styrene resin, acrylate, methacrylate, cyclic olefin, alternating copolymer, hybrid polymer, cyclo polymer, and a combination thereof.

32. An exposure apparatus having an objective lens that is cleaned in-situ, the exposure apparatus applicable in an immersion lithograph system comprising:
an optical casing;
an exposure light source, disposed in the optical casing;
an objective lens, disposed on the optical casing;
a wafer-scanning stage, disposed under the objective lens, for supporting a wafer;
an immersion chamber, disposed under the objective lens and above the wafer-scanning stage, for accommodating a liquid; and
a cleaning wafer, configured on the wafer-scanning stage to provide a cleaning component to clean the objective lens, wherein the cleaning wafer is movable on the wafer-scanning stage.

33. The exposure apparatus of claim 32 further comprising an ultrasonic vibrator, disposed at the immersion chamber to vibrate the fluid in the immersion chamber or disposed at a supply conduit of a fluid supply/discharge system to provide water that has been subjected to vibration to the immersion chamber.

34. The exposure apparatus of claim 32, wherein the cleaning wafer comprises:
a wafer; and
a detergent layer, disposed on the wafer, wherein the detergent layer includes a dried coating layer and the coating layer comprises a composition, the composition comprises:
5-20 wt % of at least a surfactant as the cleaning component;
10-50 wt % of at least a third solvent;
5-25 wt % of at least a film-forming polymer; and
optionally 1-5 wt % of an additive.
